(19) United States
(12) Patent Application Publication
(10) Pub. No.: US 2023/0004419 A1
(43) Pub. Date: Jan. 5, 2023

(54) Resource Migration Method and System, and Device

(71) Applicant: Huawei Cloud Computing Technologies Co., Ltd., Guizhou (CN)

(72) Inventors: Leiming Du, Xi'an (CN); Shuming Jing, Beijing (CN); Xiao Ling, Gui'an (CN)

(21) Appl. No.: 17/940,286

(22) Filed: Sep. 8, 2022

Related U.S. Application Data
(63) Continuation of application No. PCT/CN2021/079673, filed on Mar. 9, 2021.

(30) Foreign Application Priority Data
Mar. 9, 2020 (CN) 202010158401.5

(51) Int. Cl. G06F 9/455

(52) U.S. Cl. CPC G06F 9/45558; G06F 9/45545; G06F 2009/4557

(57) ABSTRACT

A resource migration method includes obtaining virtual resource utilization of a virtual machine, inputting the virtual resource utilization of the virtual machine into an identification model, determining a resource type of the virtual machine, obtaining physical resource utilization of the at least one physical host, inputting the physical resource utilization of the at least one physical host into the identification model, determining a resource type of each of the at least one physical host, and migrating the virtual machine to one of the at least one physical host based on the resource type of the virtual machine and the resource type of each of the at least one physical host.

### CROSS-REFERENCE TO RELATED APPLICATIONS

This is a continuation of International Patent Application No. PCT/CN2021/079673 filed on Mar. 9, 2021, which claims priority to Chinese Patent Application No. 202010158401.5 filed on Mar. 9, 2020, the disclosure of which is hereby incorporated by reference in its entirety.

### TECHNICAL FIELD

This disclosure relates to the communications field, and in particular, to a resource migration method and system, and a device.

### BACKGROUND

With continuous development of cloud computing technologies and continuous expansion of a computing scale, cloud computing faces increasing system challenges. In a process of dealing with these challenges, resource scheduling is a key step, and in a framework of resource scheduling, resource migration is the core of resource scheduling. Efficiency of resource migration technologies determines efficiency of an entire scheduling system and further determines overall costs and business efficiency of cloud computing.

Currently, there are two resource migration solutions for migrating a to-be-migrated virtual machine to a target physical host in a resource pool. A first solution is to select a physical host in the resource pool whose specification is the same as a specification of the virtual machine as the target physical host. In this method, only the specification of the virtual machine is considered, but a current running status of the virtual machine is not considered, which easily causes a great waste of resources. A second method is to determine the target physical host based on historical utilization of the to-be-migrated virtual machine. In this method, only the historical utilization of the virtual machine is considered, and consequently, a resource occupation status of the virtual machine cannot be comprehensively described. Especially, when specific services on the virtual machine and the target physical host are complex and frequently-changing, using the second method to perform resource migration easily causes an increase in delays of some services on the target physical host after migration, and poor user experience.

### SUMMARY

This disclosure provides a resource migration method and system, and a related apparatus, to resolve the foregoing problem that waste of resources and delays of some services are easily caused in a resource migration process.

According to a first aspect, a resource migration method is provided. The method is applied to a resource provisioning system, the resource provisioning system includes at least one physical host, each of the at least one physical host includes a plurality of types of hardware resources, the hardware resources of each of the at least one physical host are virtualized into a plurality of types of virtual resources for use by a virtual machine running on the physical host, and the method includes: obtaining virtual resource utilization of a virtual machine, where the virtual resource utilization of the virtual machine may include any one or more of the following: virtual central processing unit (CPU) utilization, virtual memory utilization, virtual disk utilization, or another virtual resource; inputting the virtual resource utilization of the virtual machine into an identification model, and determining a resource type of the virtual machine; obtaining physical resource utilization of the at least one physical host, where the at least one physical host may be all physical hosts in the resource provisioning system, or may be some physical hosts in the resource provisioning system; and the physical resource utilization of the at least one physical host includes any one or more of the following: CPU utilization, memory utilization, disk utilization, or another physical resource; inputting the physical resource utilization of the at least one physical host into the identification model, and determining a resource type of each of the at least one physical host; and migrating the virtual machine to one of the at least one physical host based on the resource type of the virtual machine and the resource type of each of the at least one physical host.

In the foregoing method, the resource types of the virtual machine and the at least one physical host are identified, a specific migration solution is selected based on a resource type identification result, and a target physical host that is most suitable for resource migration of the virtual machine is determined. This avoids waste of resources caused because a target physical host that is most suitable for resource migration of a virtual machine cannot be determined due to limited learning of resource utilization of the virtual machine, avoids a service delay and a resource clash, and improves user experience.

In an embodiment, the resource type of the virtual machine includes a stable type. When the resource type of the virtual machine is the stable type, the migrating the virtual machine to one of the at least one physical host based on the resource type of the virtual machine and the resource type of each of the at least one physical host includes: obtaining at least one stable-type physical host whose resource type is the stable type; predicting, based on the virtual resource utilization of the virtual machine and physical resource utilization of the at least one stable-type physical host, a predicted value of physical resource utilization obtained after the virtual machine is migrated to each of the at least one stable-type physical host, to obtain at least one predicted value of physical resource utilization; determining that a stable-type physical host corresponding to a smallest predicted value of physical resource utilization in the at least one predicted value of the physical resource utilization as a target physical host; and migrating the virtual machine to the target physical host.

It can be understood that resource utilization of a stable-type virtual machine and a stable-type physical host is stable data. For example, a CPU utilization curve is a stable curve. Therefore, if a stable-type virtual machine is migrated to another stable-type physical host, a predicted value of physical resource utilization of the target physical host that is obtained after resource migration is performed on the virtual machine can be accurately predicted based on various types of virtual resource utilization of the virtual machine and various types of physical resource utilization of the physical host. In this way, after the stable type host with the lowest physical resource utilization is selected as the target physical host for resource migration, the virtual resource utilization of the virtual machine is lowered, and the physical resource utilization of the target physical host is increased but is still within a normal working range (it has been predicted that after resource migration, physical resource utilization of the target physical host is the lowest compared with physical resource utilization of other physical hosts). Therefore, a resource migration process does not affect the virtual machine and target physical host, and does not cause a service delay.

In an embodiment, the resource type of the virtual machine includes a periodic type. When the resource type of the virtual machine is the periodic type, the migrating the virtual machine to one of the at least one physical host based on the resource type of the virtual machine and the resource type of each of the at least one physical host includes: obtaining, at least one periodic-type physical host whose resource type is the periodic type; determining, based on the virtual resource utilization of the virtual machine and physical resource utilization of the at least one periodic-type physical host, a periodic-type physical host whose physical resource utilization curve satisfies a peak-shaving and valley-filling feature with a virtual resource utilization curve of the virtual machine as a target physical host, where when the virtual machine is in a highest utilization state, the periodic-type physical host whose physical resource utilization curve satisfies the peak-shaving and valley-filling feature with the virtual resource utilization curve is in a lowest utilization state, or when the virtual machine is in a lowest utilization state, the periodic-type physical host whose physical resource utilization curve satisfies the peak-shaving and valley-filling feature with the virtual resource utilization curve is in a high utilization state; and migrating the virtual machine to the target physical host.

It may be understood that, because a resource utilization curve of a periodic-type virtual machine is a periodic curve, a high resource utilization state and a low resource utilization state of the virtual machine are regular. A target physical host is in a low resource utilization state in time if the virtual machine is in a high resource utilization state, and the target physical host is in a low resource utilization state in time if the virtual machine is in a high resource utilization state. In this case, after a resource of the virtual machine is migrated to the target physical host, resource utilization of the target physical host is stable. In this way, that the resource utilization of the target physical host fluctuates after resource migration is avoided, and further a service delay in a resource migration process is avoided.

In an embodiment, the inputting the virtual resource utilization of the virtual machine into an identification model, and determining a resource type of the virtual machine includes: determining a coefficient of variation (CV) between each piece of data and at least one piece of other data in virtual resource utilization of each of at least one virtual machine, to obtain at least one CV coefficient vector, where each of the at least one CV coefficient vector corresponds to one virtual machine, and each of the at least one CV coefficient vector includes at least one CV coefficient; clustering the at least one CV coefficient vector to obtain at least one first coefficient set, where each of the at least one first coefficient set includes at least one CV coefficient vector, and each of the at least one first coefficient set corresponds to at least one virtual machine; and determining that at least one virtual machine that corresponds to a first coefficient set in which each CV coefficient is less than a threshold is of a stable type.

In an embodiment, after the at least one CV coefficient vector is clustered to obtain the at least one first coefficient set, the method further includes: re-clustering a CV coefficient vector in at least one first coefficient set in which a CV coefficient is greater than the threshold, to obtain at least one second coefficient set, where each of the at least one second coefficient set includes at least one CV coefficient vector, and each of the at least one second coefficient set corresponds to at least one virtual machine; and determining that at least one virtual machine corresponding to a second coefficient set in which each CV coefficient is less than the threshold is of a stable type.

It may be understood that, in the stable recognition method provided in the foregoing embodiment, a CV coefficient is used as a basic indicator for calculation. Therefore, compared with another indicator such as a standard deviation, for the CV coefficient, a measurement unit does not need to be considered, and whether a sample difference is excessively large does not need to be considered, so that stable identification precision can be improved. In addition, a method in which comparison with a threshold is performed after clustering is performed is used, so that whether a group of virtual machines are of a stable type can be determined at one time, which can improve efficiency of stable identification and further improve efficiency of resource migration.

In an embodiment, the inputting the virtual resource utilization of the virtual machine into an identification model, and determining a resource type of the virtual machine includes: performing Fourier transform on the virtual resource utilization of the virtual machine to obtain a Fourier curve; determining a difference between a peak and a trough of the Fourier curve; and when the difference is less than a threshold, determining that a virtual machine corresponding to the Fourier curve is of a periodic type.

It may be understood that, in the periodic identification method provided in the foregoing embodiment, Fourier transform is performed on the virtual resource utilization to obtain the Fourier curve, and whether the virtual machine is a periodic-type virtual machine is determined by determining whether the difference between a peak and a trough of the Fourier curve is less than the threshold. In this method, whether a virtual machine is a periodic-type virtual machine can be quickly determined through simple calculation. This method is highly feasible and easy to implement, and an identification process does not need to occupy a large quantity of resources, improving efficiency of resource migration.

According to a second aspect, a resource migration system is provided, applied to a resource provisioning system. The resource provisioning system includes at least one physical host, each of the at least one physical host includes a plurality of types of hardware resources, the hardware resources of each of the at least one physical host are virtualized into a plurality of types of virtual resources for use by a virtual machine running on the physical host, and the resource migration system includes an obtaining unit, an identification unit, and a migration unit.

The obtaining unit is configured to obtain virtual resource utilization of a virtual machine.

The identification unit is configured to: input the virtual resource utilization of the virtual machine into an identification model, and determine a resource type of the virtual machine.

The obtaining unit is further configured to obtain physical resource utilization of the at least one physical host.

The identification unit is further configured to: input the physical resource utilization of the at least one physical host into the identification model, and determine a resource type of each of the at least one physical host.

The migration unit is configured to migrate the virtual machine to one of the at least one physical host based on the resource type of the virtual machine and the resource type of each of the at least one physical host.

In an embodiment, the resource type of the virtual machine includes a stable type. When the resource type of the virtual machine is the stable type, the obtaining unit is further configured to obtain at least one stable-type physical host whose resource type is the stable type, the migration unit is further configured to predict, based on the virtual resource utilization of the virtual machine and physical resource utilization of the at least one stable-type physical host, a predicted value of physical resource utilization obtained after the virtual machine is migrated to each of the at least one stable-type physical host, to obtain at least one predicted value of physical resource utilization, the migration unit is further configured to determine that a stable-type physical host corresponding to a smallest predicted value of physical resource utilization in the at least one predicted value of the physical resource utilization as a target physical host, and the migration unit is further configured to migrate the virtual machine to the target physical host.

In an embodiment, the resource type of the virtual machine includes a periodic type. When the resource type of the virtual machine is the periodic type, the obtaining unit is further configured to obtain at least one periodic-type physical host whose resource type is the periodic type, the migration unit is further configured to determine, based on the virtual resource utilization of the virtual machine and physical resource utilization of the at least one periodic-type physical host, a periodic-type physical host whose physical resource utilization curve satisfies a peak-shaving and valley-filling feature with a virtual resource utilization curve of the virtual machine as a target physical host, where when the virtual machine is in a highest utilization state, the periodic-type physical host whose physical resource utilization curve satisfies the peak-shaving and valley-filling feature with the virtual resource utilization curve is in a lowest utilization state, or when the virtual machine is in a lowest utilization state, the periodic-type physical host whose physical resource utilization curve satisfies the peak-shaving and valley-filling feature with the virtual resource utilization curve is in a high utilization state, and the migration unit is further configured to migrate the virtual machine to the target physical host.

In an embodiment, the identification unit is configured to: determine a CV between each piece of data and at least one piece of other data in virtual resource utilization of each of at least one virtual machine, to obtain at least one CV coefficient vector, where each of the at least one CV coefficient vector corresponds to one virtual machine, and each of the at least one CV coefficient vector includes at least one CV coefficient; cluster the at least one CV coefficient vector to obtain at least one first coefficient set, where each of the at least one first coefficient set includes at least one CV coefficient vector, and each of the at least one first coefficient set corresponds to at least one virtual machine; and determine that at least one virtual machine that corresponds to a first coefficient set in which each CV coefficient is less than a threshold is of a stable type.

In an embodiment, after the at least one CV coefficient vector is clustered to obtain the at least one first coefficient set, the method further includes: the identification unit is configured to: re-cluster a CV coefficient vector in at least one first coefficient set in which a CV coefficient is greater than the threshold, to obtain at least one second coefficient set, where each of the at least one second coefficient set includes at least one CV coefficient vector, and each of the at least one second coefficient set corresponds to at least one virtual machine; and determine that at least one virtual machine corresponding to a second coefficient set in which each CV coefficient is less than the threshold is of a stable type.

In an embodiment, the inputting the virtual resource utilization of the virtual machine into an identification model, and determining a resource type of the virtual machine includes: the identification unit is configured to: perform Fourier transform on the virtual resource utilization of the virtual machine to obtain a Fourier curve; determine a difference between a peak and a trough of the Fourier curve; and when the difference is less than a threshold, determine that a virtual machine corresponding to the Fourier curve is of a periodic type.

According to a third aspect, a computer program product is provided. When the computer program product is read and executed by a computing device, the method described in the first aspect is implemented.

According to a fourth aspect, a computer non-transitory storage medium is provided, including instructions. When the instructions are run on a computing device, the computing device is enabled to implement the method described in the first aspect.

According to a fifth aspect, an electronic device is provided, including a processor and a memory. When the processor executes code in the memory, the method described in the first aspect is implemented.

### BRIEF DESCRIPTION OF DRAWINGS

To describe technical solutions in embodiments of this disclosure or other technologies more clearly, the following briefly describes the accompanying drawings used in descriptions of embodiments and the other technologies.

FIG. 1A is a schematic diagram of a structure of a resource provisioning system.

FIG. 1B is a schematic flowchart of resource migration.

FIG. 2 is a schematic diagram of an application environment of a resource migration system according to this disclosure.

FIG. 3 is a schematic flowchart of a resource migration method according to this disclosure.

FIG. 4 and FIG. 5 are schematic flowcharts of a resource migration method in an application scenario according to this disclosure.

FIG. 6 is a schematic flowchart of a resource migration method in another application scenario according to this disclosure.

FIG. 7 is a schematic diagram of a structure of a resource migration system according to this disclosure.

FIG. 8 is a schematic diagram of a structure of an electronic device according to this disclosure.

### DESCRIPTION OF EMBODIMENTS

The following describes technical solutions in embodiments of the present disclosure with reference to the accompanying drawings in embodiments of the present disclosure. It is clear that the described embodiments are merely some but not all of embodiments of the present disclosure. All other embodiments obtained by persons of ordinary skill in the art based on embodiments of the present disclosure without creative efforts shall fall within the protection scope of the present disclosure.

To facilitate understanding of embodiments of this disclosure, an application scenario in this disclosure is first briefly described.

A cloud service is a product of development and combination of computer and network technologies, such as distributed computing, parallel computing, utility computing, network storage (e.g., Network Storage Technologies), virtualization, load balancing, and a content delivery network. The cloud service is a mode of adding, using, and interacting with related services based on the Internet, and is usually related to providing dynamical, scalable, and often virtualized resources through the Internet. It is understandable that cloud is a metaphor of a network and the Internet. In the past, cloud was usually used to represent a telecommunications network in diagrams, and later the cloud is also used to abstractly represent the Internet and an underlying infrastructure. The cloud service actually refers to obtaining a required service through a network in an on-demand and extensible manner. Such a service may be related to information technology (IT), software, and the Internet, or may be another service, and means that a computing capability can also be circulated as a commodity through the Internet.

Briefly, a plurality of customers can share system resources of one cloud service provider. The customers can enjoy professional IT services, for example, purchasing a virtual machine as a server of a company, without deploying any device or configuring management personnel. This can greatly reduce operation costs for common entrepreneurs and small- and medium-sized enterprises. For a cloud service provider, after a user purchases a virtual machine from the cloud service provider, the cloud service provider may select an appropriate and idle virtual machine from a cloud service resource pool and provide the virtual machine for the user. Because a system resource purchased by the user is in an idle state, the system resource may be leased to a customer, so that resource utilization of the cloud service provider is improved.

However, with continuous development of cloud computing technologies and continuous expansion of a computing scale, cloud computing faces increasing system challenges. In a process of dealing with these challenges, resource scheduling is a key step. It may be understood that, in a resource pool of a cloud service provider, there is usually at least one physical host each configured with a different specification, and each physical host may be divided into at least one virtual machine each configured with a different specification. Therefore, how to properly allocate and schedule a resource based on a user requirement is one of important challenges faced in cloud computing. In a framework of resource scheduling, resource migration is the core for implementing resource scheduling. It should be understood that the resource migration refers to migrating a virtual machine that is being used by a user to a specific physical host in a target resource pool. There are many reasons for the resource migration. For example, after a resource is allocated and scheduled based on a requirement of the user, because a requirement of the user for the resource may change during use, resource migration is required in this case. For another example, utilization of a physical host A in a resource pool is 80%, but utilization of another physical host B is only 10%. In this case, a resource scheduling system may migrate some virtual machine resources of the physical host A to the physical host B, so that the utilization of the physical host A is lowered, and a running speed of the physical host A is improved. It may be understood that reasons for the resource migration may further include other scenarios, and examples are not described herein one by one. In conclusion, efficiency of resource migration technologies determines efficiency of an entire scheduling system and further determines overall costs and business efficiency of cloud computing.

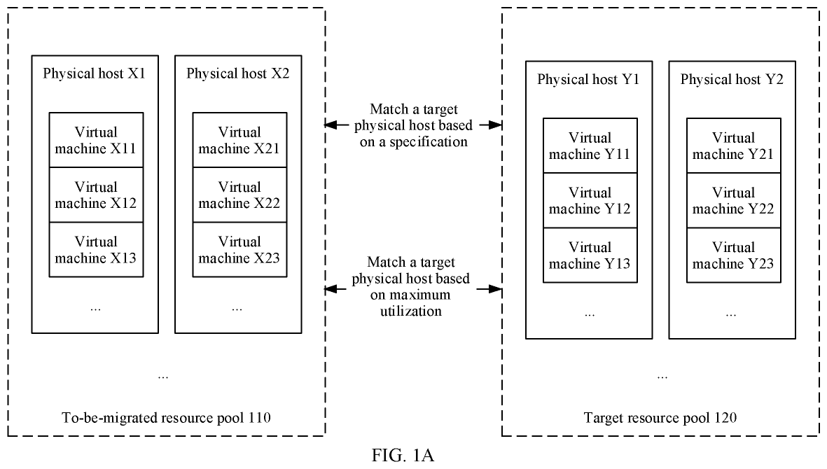

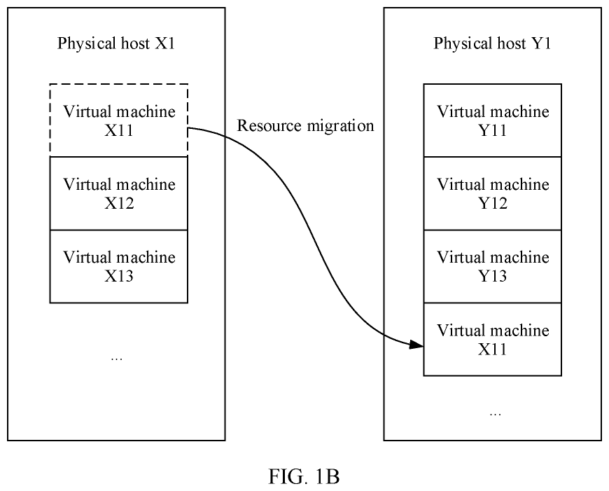

FIG. 1A is a schematic diagram of a structure of a resource provisioning system 100. The resource provisioning system 100 includes a to-be-migrated resource pool 110 and a target resource pool 120. A system in each of the to-be-migrated resource pool 110 and the target resource pool 120 may include at least one physical host. For example, in FIG. 1A, the to-be-migrated resource pool 110 may include a physical host X1, a physical host X2, and so on, and the to-be-migrated resource pool 120 may include a physical host Y1, a physical host Y2, and so on. Each of the at least one physical host includes a plurality of types of hardware resources, is configured to provide a user with various IaaS cloud services, such as a cloud host, cloud storage, and bandwidth, may further provide a user with a platform as a service (PaaS) such as a relational database service (RDS) and software as a service (SaaS), and may further provide abundant cloud services that can be used through a network, such as software development cloud. This is not limited in this disclosure. The foregoing hardware resources of each of the at least one physical host may also be virtualized into a plurality of types of virtual resources for use by a virtual machine running on the physical host. For example, in FIG. 1A, the physical host X1 may include virtual machines X11, X12, X13, and so on, and the physical host X2 may include virtual machines X21, X22, X23, and so on. The physical host Y1 may include virtual machines Y11, Y12, Y13, and so on, and the physical host Y2 may include virtual machines Y21, Y22, Y23, and so on. It should be understood that FIG. 1 is merely used as an example for description. Neither a quantity of physical hosts in the resource pool nor a quantity of virtual machines in the physical host is limited in this disclosure. In addition, the target resource pool 120 and the to-be-migrated resource pool 110 may be two different resource pools, or may be a same resource pool, or may be two resource pools in which some resources are the same and some resources are different. This is not limited in this disclosure.

Resource migration may be simply understood as selecting a target physical host from the target resource pool 120 to migrate a to-be-migrated resource in a virtual machine in the to-be-migrated resource pool 110 to the target physical host. For example, it is assumed that resource migration is performed on the virtual machine X11 on the physical host X1 in the to-be-migrated resource pool 110 in FIG. 1A, and the target physical host is the physical host Y1 in the target resource pool 120. A resource migration process may be shown in FIG. 1B. As shown in FIG. 1B, after a resource of the virtual machine X11 is migrated to the physical host Y1, the physical host X1 does not include the virtual machine X11, and the physical host Y1 includes the virtual machine X11. It may be understood that, after the resource migration, physical resource utilization of the source physical host X1 on which the virtual machine was located is decreased, but physical resource utilization of the target physical host is definitely increased. If physical resource utilization of a physical host is high, and another virtual machine is migrated to the physical host, the physical host is inevitably affected, and a service on another virtual machine on the physical host is affected, or even the physical host crashes, and user service data is lost. Therefore, efficiency of resource migration technologies not only determines efficiency of an entire scheduling system but also determines overall costs and business efficiency of cloud computing.

It can be learned from FIG. 1A that currently, there are mainly two resource migration solutions for migrating a to-be-migrated virtual machine to a target physical host. A first method is to select, in the target resource pool 120, a physical host that includes a virtual machine whose specification is the same as a specification of the to-be-migrated virtual machine as the target physical host, for example, perform matching based on a specification of a CPU. In this method, only the specification of the virtual machine is considered, but a current running status of the virtual machine is not considered, which easily causes a great waste of resources. A second method is to determine, in the target resource pool 120, the target physical host based on historical utilization of the virtual machine. In this method, only the historical utilization of the virtual machine is considered, and consequently, a resource utilization status of the virtual machine cannot be comprehensively described. Especially, when specific services on the virtual machine and the physical host are complex and changeable, using the second method to perform resource migration easily causes an increase in delays of some services, and causes a resource clash. Consequently, a resource migration process has adverse impact on a user, and user experience is poor.

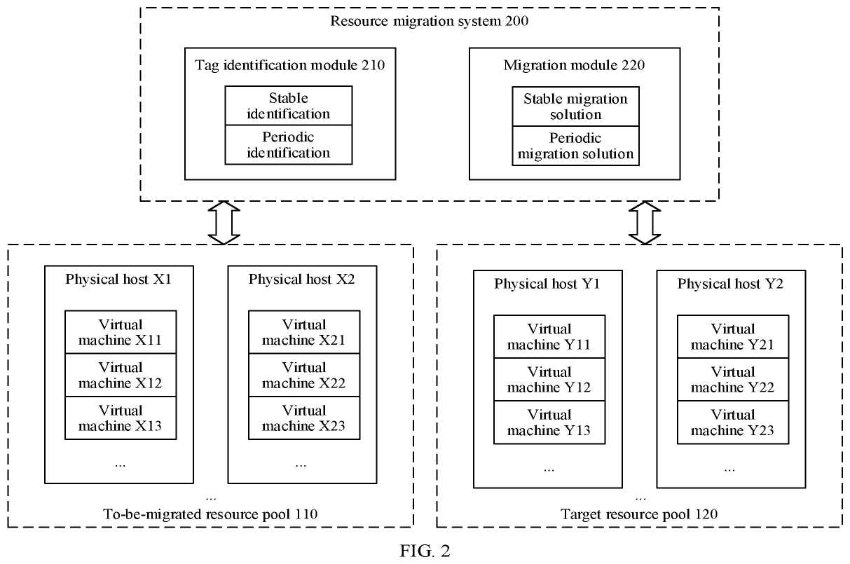

To resolve the foregoing problem that waste of resources and delays of services are easily caused in a resource migration process, this disclosure provides a resource migration system 200. As shown in FIG. 2, the resource migration system 200 provided in this disclosure may perform resource type identification for a resource occupation status of a virtual machine in a to-be-migrated resource pool 110, select a specific migration solution based on a resource type identification result, and determine, in a target resource pool 120, a target physical host that is most suitable for resource migration of the virtual machine, to avoid waste of resources, a service delay, and a resource clash, and improve user experience. For the target resource pool 120 and the to-be-migrated resource pool 110, refer to the content described in the embodiment in FIG. 1A and FIG. 1B. Details are not described herein again. It should be noted that internal unit modules of the resource migration system 200 shown in FIG. 2 may be obtained through division in a plurality of manners, and the modules may be software modules, or may be hardware modules, or some modules may be software modules and the other modules may be hardware modules. This is not limited in this disclosure. FIG. 2 is an example of a division manner. This is not limited in this disclosure.

As shown in FIG. 2, the resource migration system 200 may include an identification module 210 and a migration module 220. The identification module 210 may separately perform resource type identification on a virtual machine and a physical host based on virtual resource utilization of the virtual machine in the to-be-migrated resource pool 110 and physical resource utilization of the physical host in the target resource pool 120. The virtual resource utilization and the physical resource utilization may be obtained after the resource migration system 200 performs real-time monitoring on information such as a CPU, memory, disk input/output (I/O), and a network Internet Protocol (IP) of each virtual machine in the to-be-migrated resource pool 110 and information such as a CPU, memory, disk I/O, and a network IP of each physical host in the target resource pool. The virtual resource utilization of the virtual machine includes any one or more of the following: virtual CPU utilization, virtual memory utilization, and virtual disk utilization, and the physical resource utilization of the at least one physical host includes any one or more of the following: CPU utilization, memory utilization, and disk utilization. In a specific implementation, the virtual CPU utilization may further include a historical CPU resource utilization curve, current CPU resource utilization, average CPU utilization, and the like. Similarly, the disk utilization may further include current disk utilization, a historical disk utilization curve, average disk utilization, and the like, and the memory utilization may further include current memory utilization, a historical memory utilization curve, average memory utilization, and the like. This is not limited in this disclosure.

The identification module 210 may include a stable identification model and a periodic identification model. The stable identification model is used to determine whether resource types of the virtual machine and the physical host are a stable type, and the periodic identification model is used to determine whether resource types of the virtual machine and the physical host are a periodic type. Virtual resource utilization of a stable-type virtual machine is data that fluctuates slightly. For example, CPU utilization has a stable curve, and memory usage has a stable curve. For example, the CPU utilization of the stable-type virtual machine may remain at 50% with fluctuation not exceeding 3%. Virtual resource utilization of a periodic-type virtual machine is data that periodically changes. For example, CPU utilization has a periodic curve, and memory usage has a periodic curve. For example, a virtual resource utilization curve of the periodic-type virtual machine may be a sine function, and may reach a maximum of 80% and a minimum of 20% in one period. It may be understood that, after the identification module determines the resource type of the virtual machine, a future change curve of a resource of the virtual machine may be well predicted. Based on this, a target physical host with a high matching degree may be selected for resource migration. This greatly avoids waste of resources, improves efficiency of resource migration, stability of a cloud service system, and resource utilization in the entire resource pool, reduces operation costs of a cloud service provider, and avoids a service delay, so that user experience is improved.

The migration module 220 may determine the target physical host based on the resource type of the virtual machine by using a migration solution corresponding to the resource type. The migration module 220 may include a stable migration solution and a periodic migration solution. When the identification module 210 determines that a virtual machine is of a stable type, the migration module 220 determines a target physical host by using the stable migration solution. When the tag identification module 210 determines that a virtual machine is of a periodic type, the migration module 220 determines a target physical host by using the periodic migration solution. The stable migration solution and the periodic migration solution are described below.

It may be understood that, because a virtual resource utilization curve of a stable-type virtual machine is a stable curve, a predicted value of physical resource utilization of a target physical host that is obtained after the virtual machine is migrated to the target physical host can be accurately predicted. Therefore, the stable migration solution may be: first obtaining at least one stable-type physical host whose resource type is also the stable type from the target resource pool 120, then predicting, based on virtual resource utilization of the virtual machine and physical resource utilization of the stable-type physical host, a predicted value of physical resource utilization of each stable-type physical host that is obtained after the virtual machine is migrated to the stable-type physical host, and then selecting a stable-type physical host that has a most appropriate margin, for example, a smallest predicted value of resource utilization, as the target physical host. For example, it is assumed that an average value of the virtual utilization of the virtual machine is 80%, stable-type physical hosts in the target resource pool 120 include a physical host 1 and a physical host 2, an average value of physical resource utilization of the physical host 1 is 35%, current utilization of the physical host 1 is 28%, an average value of physical resource utilization of the physical host 2 is 44%, and current utilization of the physical host 2 is 40%. If the virtual machine is migrated to the physical host 1, a predicted value of the physical utilization of the physical host 1 may be 32% after migration, and a predicted value of the physical resource utilization of the physical host 2 may be 42%. In this case, the physical host 1 may be determined as the target physical host, and the virtual machine is migrated to the target physical host. It should be understood that the foregoing example is merely used for description. This is not limited in this disclosure.

It may be understood that, for a periodic-type virtual machine, a virtual resource utilization curve of the virtual machine is a periodic curve, and a high utilization state and a low utilization state of the virtual machine are regular. Therefore, the periodic migration solution may be: first obtaining at least one periodic-type physical host whose resource type is also the periodic type from the target resource pool 120, and then determining, based on virtual resource utilization of the virtual machine and physical resource utilization of the at least one periodic-type physical host, a periodic-type physical host whose physical resource utilization curve satisfies a peak-shaving and valley-filling feature with the virtual resource utilization curve as a target physical host. When the virtual machine is in a highest utilization state, the periodic-type physical host whose physical resource utilization curve satisfies the peak-shaving and valley-filling feature with the virtual resource utilization curve is in a lowest utilization state. When the virtual machine is in a lowest utilization state, the periodic-type physical host whose physical resource utilization curve satisfies the peak-shaving and valley-filling feature with the virtual resource utilization curve is in a high utilization state. Peak-shaving and valley-filling can also be simply understood as that a sum of the virtual resource utilization curve and the physical resource utilization curve is a stable curve. For example, it is assumed that a CPU utilization fitting curve of a virtual machine A in one period is y=sin x, where y is CPU utilization of the virtual machine A, and x is time. If a CPU utilization fitting curve of a periodic-type physical host B in one period is y=−sin x, the periodic-type physical host B may be a target physical host of the virtual machine A. It should be understood that the foregoing example is merely used for description. This is not limited in this disclosure.

In conclusion, the resource migration system 200 provided in this disclosure may identify the resource types of the virtual machine in the to-be-migrated resource pool 110 and the physical host in the target resource pool 120. For the stable-type virtual machine, a stable-type physical host with a smallest predicted value of physical resource utilization is selected as a target physical host for resource migration. For the periodic-type virtual machine, a periodic-type resource whose physical resource utilization curve satisfies a peak-shaving and valley-filling feature with the virtual resource utilization curve of the virtual machine is selected as a target physical host for resource migration. In a process of determining the target physical host, the system not only considers a current resource utilization status of the virtual machine, but also considers a possible physical resource utilization status of the target physical host that is obtained after migration. Based on this, a target physical host with a high matching degree may be selected for resource migration. This greatly avoids waste of resources, improves efficiency of resource migration, stability of a cloud service system, and resource utilization in the entire resource pool, reduces operation costs of a cloud service provider, and avoids a service delay, so that user experience is improved.

With reference to the accompanying drawings, the following describes in detail how the resource migration system 200 shown in FIG. 2 resolves a problem that waste of resources and a service delay easily occur in a resource migration process.

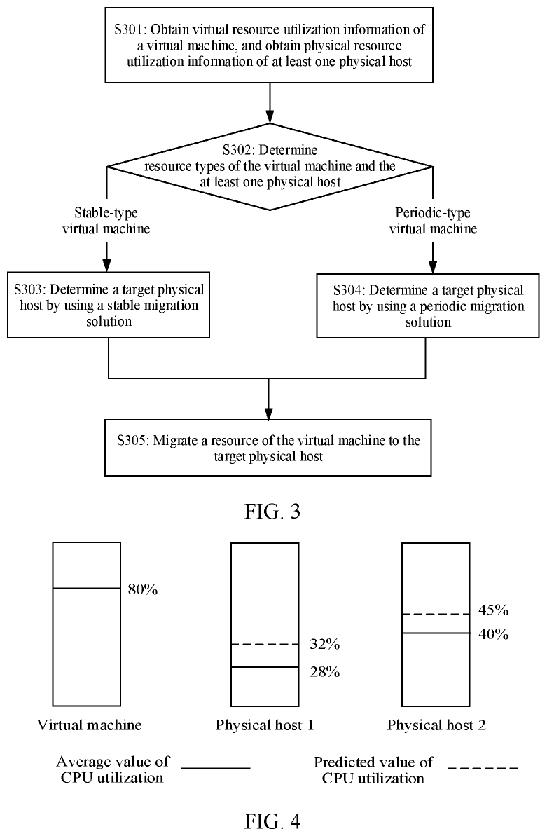

As shown in FIG. 3, this disclosure provides a resource migration method, which may be applied to the resource migration system 200 shown in FIG. 2. The method may include the following steps.

S310: Obtain virtual resource utilization of a virtual machine, where the virtual resource utilization of the virtual machine includes any one or more of the following: virtual CPU utilization, virtual memory utilization, and virtual disk utilization; and obtain physical resource utilization of at least one physical host, where the physical resource utilization of the at least one physical host includes any one or more of the following: CPU utilization, memory utilization, and disk utilization. The at least one physical host may be all physical hosts in a target resource pool 120 of a resource provisioning system, or may be some physical hosts in a target resource pool 120 of a resource provisioning system. This is not limited in this disclosure.

It should be noted that the virtual resource utilization and the physical resource utilization may be obtained after real-time monitoring is performed on information such as a CPU, memory, disk I/O, and a network IP of each virtual/physical resource in a to-be-migrated resource pool 110 and the target resource pool, and may include a historical CPU resource utilization curve, current CPU resource utilization, current disk usage, a historical disk usage curve, current memory usage, a historical memory usage curve, and the like. Certainly, to improve a computation speed, only historical CPU resource utilization may be considered for calculation. This is not limited in this disclosure. In addition, in step S310, the virtual resource utilization of the virtual machine may be first obtained from the to-be-migrated resource pool 110, and then the physical resource utilization of the at least one physical host is obtained from the target resource pool 120; or the physical resource utilization may be first obtained and then the virtual resource utilization is obtained; or the virtual resource utilization and the physical resource utilization may be obtained simultaneously. This is not limited in this disclosure.

In an embodiment, the virtual resource utilization and the physical resource utilization may alternatively be obtained after data processing is performed on the foregoing real-time monitored data. It may be understood that the real-time monitored data is originally-collected data, which has a wide source, a large quantity, and a relatively complex data structure. If resource type identification is directly performed on resource utilization in the unsystematic original monitored data, not only an operation speed is low, but also heavy burden is caused to a processor. Therefore, a unified and efficient manner is required for organizing and storing the real-time monitored data, and “translating” the real-time monitored data into data in a unified format that can be read and written by the processor, so that the processor can further identify a resource type in a unified manner. The real-time monitored data can be stored in different structures, such as tables, objects, trees, and charts.

In a specific implementation, a data processing process may include data cleaning, normalization, clustering, and the like, and may further include another data processing method in which data in a unified format and in an efficient organization manner can be obtained based on the originally-collected data. Examples are not described one by one in this disclosure. Only data cleaning is used as an example to describe the data processing process below. Data cleaning means that when the real-time monitored data includes noise or incomplete information, steps such as data cleaning may be performed to improve accuracy of a subsequent identification result. A step of the data cleaning may include filling in a vacancy value, smoothing noise data, deleting an isolated point, checking whether a format and content of each attribute of data comply with a standard, and the like. Less-dimension abstraction processing is performed on redundant data by using a linear or nonlinear mathematical transform method, to retain a part that has highest existence and analysis value in the data, so as to reduce storage space occupied by the data while ensuring relative data integrity, so that data smaller than the original data is obtained, facilitating subsequent work. After the real-time monitored data is cleaned, data reliability is greatly improved, which lays a foundation for a subsequent resource type identification process. It should be understood that the foregoing example is merely used for description. This is not limited in this disclosure.

S320: Input the virtual resource utilization of the virtual machine into an identification model, and determine a resource type of the virtual machine; and input the physical resource utilization of the at least one physical host into the identification model, and determine a resource type of each of the at least one physical host. The identification model includes a stable identification model and a periodic identification model. Resource types of the virtual machine and the physical host include a periodic type and a stable type. The stable identification model is used to determine, based on the virtual resource utilization, whether the virtual machine is a stable-type virtual machine, and determine, based on the physical resource utilization, whether the physical host is a stable-type physical host. The periodic identification model is used to determine, based on the virtual resource utilization, whether the virtual machine is a periodic-type virtual machine, and determine, based on the physical resource utilization, whether the physical host is a stable-type physical host. Herein, for definitions of the stable type and the periodic type, refer to the embodiment in FIG. 2, and details are not described herein again.

It should be noted that, when the resource type of the virtual machine is the stable type, step S330 is performed; or when the resource type of the virtual machine is the periodic type, step S340 is performed.

S330: Determine, based on the resource utilization of the virtual machine and physical resource utilization of at least one stable-type physical host, a target physical host corresponding to the virtual machine by using a stable migration solution. Specific steps of the stable migration solution are described in detail in the following step S331 to step S333.

S340: Determine, based on the resource utilization of the virtual machine and physical resource utilization of at least one periodic-type physical host, a target physical host corresponding to the virtual machine by using a periodic migration solution. Specific steps of the periodic migration solution are described in detail in the following step S341 to step S343.

S350: Migrate a resource of the virtual machine to the target physical host.

The identification model in step S320 is explained and described below.

In an embodiment, the identification model in step S320 includes a stable identification model and a periodic identification model. Both the stable identification model and the periodic identification model may be models trained in advance, and may be obtained by using one or more of algorithms such as machine learning, deep learning, inference, an association rule, clustering, and a decision tree. This is not limited in this disclosure. An implementation of the periodic identification model and an implementation of the stable identification model are separately provided below for detailed description.

In an embodiment, a specific identification process of the periodic identification model may be as follows: The inputting the virtual resource utilization of the virtual machine into an identification model, and determining a resource type of the virtual machine includes: performing Fourier transform on the virtual resource utilization of the virtual machine to obtain a Fourier curve; determining a difference between a peak and a trough of the Fourier curve; and when the difference is less than a threshold, determining that a virtual machine corresponding to the Fourier curve is of a periodic type. For example, Fourier transform may be first performed on a CPU utilization curve of the virtual machine to obtain a transformed curve, and then a difference between a peak and a trough of the transformed curve is determined. When the difference is less than 0.1, it is determined that the virtual machine is a periodic-type virtual machine. Similarly, whether the resource type of the at least one physical host in the target resource pool 120 is the periodic type may be determined. It should be understood that the foregoing example is merely used for description, and does not constitute a specific limitation.

In an embodiment, a specific identification process of the stable identification model may be as follows: The inputting the virtual resource utilization of the virtual machine into an identification model, and determining a resource type of the virtual machine includes: determining a CV between each piece of data and at least one piece of other data in virtual resource utilization of each of at least one virtual machine, to obtain at least one CV coefficient vector, where each of the at least one CV coefficient vector corresponds to one virtual machine, and each of the at least one CV coefficient vector includes at least one CV coefficient; clustering the at least one CV coefficient vector to obtain at least one first coefficient set, where each of the at least one first coefficient set includes at least one CV coefficient vector, and each of the at least one first coefficient set corresponds to at least one virtual machine; determining that at least one virtual machine that corresponds to a first coefficient set in which each CV coefficient is less than a threshold is of a stable type; re-clustering a CV coefficient vector in at least one first coefficient set in which a CV coefficient is greater than the threshold, to obtain at least one second coefficient set, where each of the at least one second coefficient set includes at least one CV coefficient vector, and each of the at least one second coefficient set corresponds to at least one virtual machine; and determining that at least one virtual machine corresponding to a second coefficient set in which each CV coefficient is less than the threshold is of a stable type.

It may be understood that a CV coefficient is a mathematical quantity representing a change degree of a variable. A smaller CV coefficient indicates that variables are more equivalent, that is, two values are more stable. Virtual resource utilization of each virtual machine (for example, CPU utilization of the virtual machine) may be a group of data including a plurality of pieces of data. After a CV coefficient is calculated between every two pieces of data in the group of data, a multi-dimensional CV coefficient vector including at least one CV coefficient may be obtained. If each element in the CV coefficient vector is less than a threshold, it indicates that the group of data is more stable. To improve calculation precision, a CV coefficient among every three pieces of data or every four pieces of data may further be calculated, to obtain a CV coefficient vector in more dimensions. In this way, a CV coefficient vector may be calculated for the virtual resource utilization of each virtual machine. Considering that there are a large quantity of virtual machines in the to-be-migrated resource pool 110, to improve efficiency of stable identification, group identification is selected for the stable identification model in this disclosure. To be specific, a CV coefficient vector of each virtual machine is clustered with a CV coefficient vector of another virtual machine to obtain at least one first coefficient set. Each first coefficient set may include at least one CV coefficient vector, and each coefficient set may correspond to at least one virtual machine. Then, a CV coefficient in each first coefficient set and a threshold are compared. If all CV coefficients in a first coefficient set are less than the threshold, all virtual machines corresponding to the first coefficient set may be determined to be of a stable type; or if a first coefficient set includes a CV coefficient that is not less than the threshold, all CV coefficients in the entire first coefficient set need to be clustered again, to obtain at least one second coefficient set; and if all CV coefficients in a second coefficient set are less than the threshold, all virtual machines corresponding to the second coefficient set may be determined to be of a stable type, and so on. The foregoing clustering and determining processes are repeated.

For example, it is assumed that the to-be-migrated resource pool 110 includes four virtual machines, resource utilization of a virtual machine A is (y₁₁, y₁₂, y₁₃), resource utilization of a virtual machine B is (y₂₁, y₂₂, y₂₃), resource utilization of a virtual machine C is (y₃₁, y₃₂, y₃₃), and resource utilization of a virtual machine D is (y₄₁, y₄₂, y₄₃). A stable identification process for the foregoing four virtual machines may be as follows:

First, CV coefficient transform is performed on the four pieces of resource utilization. It is assumed that only a CV coefficient between every two pieces of data is calculated. Therefore, a CV coefficient vector of the virtual machine A may be (k₁₁, k₁₂, k₁₃), where k₁₁ is a CV coefficient between y₁₁ and y₁₂, k₁₂ is a CV coefficient between y₁₂ and y₁₃, and k₁₃ is a CV coefficient between y₁₁ and y₁₃. By analogy, it can be learned that a CV coefficient vector of the virtual machine B is (k₂₁, k₂₂, k₂₃), a CV coefficient vector of the virtual machine C is (k₃₁, k₃₂, k₃₃), and a CV coefficient vector of the virtual machine D is (k₄₁, k₄₂, k₄₃).

Then, the four CV coefficient vectors are clustered to obtain two first coefficient sets, and each set includes two CV coefficient vectors that respectively correspond to two virtual machines. It is assumed that, after clustering is performed, CV vectors of the virtual machine A and the virtual machine C are clustered into one first coefficient set (k₁₁, k₁₂, k₁₃, k₃₁, k₃₂, k₃₃), and CV vectors of the virtual machine B and the virtual machine D are clustered into the other first coefficient set (k₂₁, k₂₂, k₂₃, k₄₁, k₄₂, k₄₃).

Finally, assuming that k₁₁, k₁₂, k₁₃, k₃₁, k₃₂, and k₃₃ are less than a threshold 0.5, both the virtual machine A and the virtual machine C are stable-type virtual machines. Assuming that one of k₂₁, k₂₂, k₂₃, k₄₁, k₄₂, and k₄₃ is not less than the threshold 0.5, k₂₁, k₂₂, k₂₃, k₄₁, k₄₂, and k₄₃ are re-clustered together with a CV coefficient vector of another virtual machine (for example, a new virtual machine E and a new virtual machine F are added to the to-be-migrated resource pool) to obtain at least one second coefficient set, then each CV coefficient in the second coefficient set is compared with the threshold 0.5, and so on.

It should be noted that the foregoing specific processes of the stable identification and the periodic identification are described by using a virtual machine as an example. In a specific implementation, stable identification and periodic identification of the at least one physical host are also implemented by using the foregoing method, and are consistent with the processes of the stable identification and the periodic identification of the virtual machine. Therefore, details are not described herein.

It may be understood that whether a virtual machine is of a stable type is identified by using the stable identification model provided in this disclosure, and a CV coefficient is used as a basic indicator for calculation. Compared with another indicator such as a standard deviation, for the CV coefficient, a measurement unit does not need to be considered, and whether a sample difference is excessively large does not need to be considered, so that stable identification precision can be improved. In addition, a method in which comparison with a threshold is performed after clustering is performed is used, so that whether a group of virtual machines are of a stable type can be determined at a time. This can improve efficiency of stable identification and further improve efficiency of resource migration.

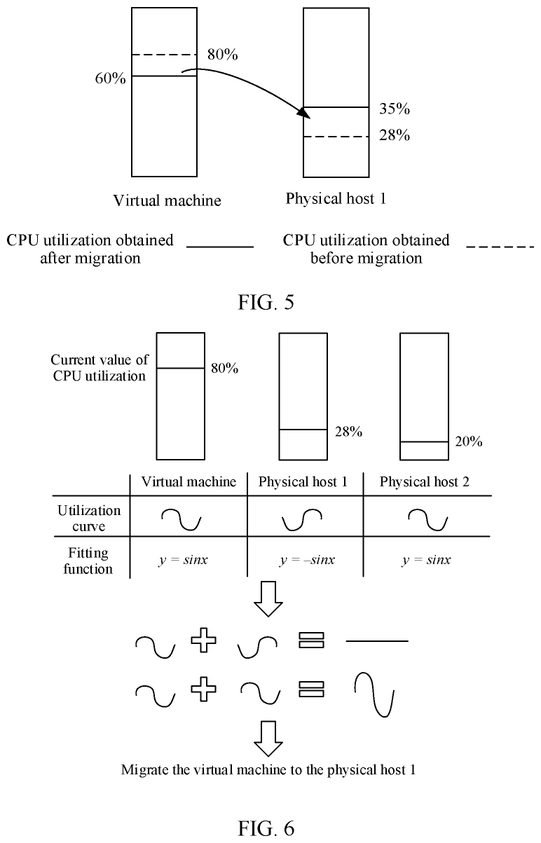

With reference to FIG. 4 and FIG. 5, and step S331 and step S332, the stable migration solution used in the foregoing step S330 is explained and described below.

According to the preceding description, resource utilization of a stable-type virtual machine and a stable-type physical host is stable data. For example, a CPU utilization curve is a stable curve. Therefore, if a stable-type virtual machine is migrated to another stable-type physical host, a change curve of physical resource utilization of the target physical host that is obtained after resource migration is performed on the virtual machine can be accurately predicted based on various types of virtual resource utilization of the virtual machine and various types of physical resource utilization of the physical host. Therefore, step S330 may include the following steps.

S331: Obtain at least one stable-type physical host whose resource type is also the stable type from the target resource pool 120.

It can be learned from the foregoing content that the resource type of the at least one physical host in the target resource pool 120 has been determined in step S320. Therefore, the at least one stable-type physical host may be obtained in step S331. The resource migration system may monitor the target resource pool 120 and the to-be-migrated resource pool 110 simultaneously, and determine resource types of the at least one host in the target resource pool 120 and the at least one virtual machine in the to-be-migrated resource pool 110 simultaneously, or may first determine the resource type of the at least one virtual machine in the to-be-migrated resource pool 110, and then determine the resource type of the at least one host in the target resource pool 120. This is not limited in this disclosure.

S332: Predict, based on the virtual resource utilization of the virtual machine and physical resource utilization of the at least one stable-type physical host, a predicted value of physical resource utilization obtained after the virtual machine is migrated to each of the at least one stable-type physical host, to obtain at least one predicted value of physical resource utilization.

For example, as shown in FIG. 4, it is assumed that an average value of CPU utilization of a virtual machine is 80%, an average value of CPU utilization of a physical host 1 is 28%, and an average value of CPU utilization of a physical host 2 is 40%. It may be predicted that after the virtual machine is migrated to the physical host 1, a predicted value of the CPU utilization of the physical host 1 is 32%, and after the virtual machine is migrated to the physical host 2, a predicted value of the CPU utilization of the physical host 2 is 45%. It should be understood that FIG. 5 is merely used as an example for description. In a specific implementation, calculation of the predicted value of physical resource utilization may alternatively be determined based on one or more of a historical CPU resource utilization curve, current CPU resource utilization, current disk usage, a historical disk usage curve, current memory usage, a historical memory usage curve, or the like. This is not limited in this disclosure.

S333: Determine a stable-type physical host corresponding to a smallest predicted value of physical resource utilization in the at least one predicted value of the physical resource utilization as the target physical host.

Still refer to the foregoing example. As shown in FIG. 4, the predicted value of the CPU utilization of the physical host 1 is the smallest. Therefore, the physical host 1 may be determined as a target physical host of the virtual machine. As shown in FIG. 5, the CPU utilization of the virtual machine that is obtained before migration is 80%, and changes to 60% after migration, and the CPU utilization of the physical host 1 that is obtained before migration is 28%, and changes to 35% after migration. It should be noted that the foregoing example is merely used for description, and does not constitute a specific limitation. It should be understood that, after resource migration, the virtual resource utilization of the virtual machine is lowered, and the physical resource utilization of the target physical host is increased but is still within a normal working range. Therefore, a resource migration process does not affect the virtual machine and the target physical host, and does not cause a service delay.

With reference to FIG. 6, and step S341 and step S342, the periodic migration solution in the foregoing step S340 is explained and described below.

It can be learned from the foregoing content that, because a resource utilization curve of a periodic-type virtual machine is a periodic curve, a high resource utilization state and a low resource utilization state of the virtual machine are regular. A target physical host is in a low resource utilization state in time if the virtual machine is in a high resource utilization state, and the target physical host is in a low resource utilization state in time if the virtual machine is in a high resource utilization state. In this case, after a resource of the virtual machine is migrated to the target physical host, resource utilization of the target physical host is stable. In this way, that the resource utilization of the target physical host fluctuates after resource migration is avoided, and further a service delay in a resource migration process is avoided. Therefore, step S340 may include the following steps.

S341: Obtain at least one periodic-type physical host whose resource type is the periodic type.

S342: Determine, based on the virtual resource utilization of the virtual machine and physical resource utilization of the at least one periodic-type physical host, a periodic-type physical host whose physical resource utilization curve satisfies a peak-shaving and valley-filling feature with a virtual resource utilization curve of the virtual machine as a target physical host, where when the virtual machine is in a highest utilization state, the periodic-type physical host whose physical resource utilization curve satisfies the peak-shaving and valley-filling feature with the virtual resource utilization curve is in a lowest utilization state, or when the virtual machine is in a lowest utilization state, the periodic-type physical host whose physical resource utilization curve satisfies the peak-shaving and valley-filling feature with the virtual resource utilization curve is in a high utilization state.

For example, it is assumed that a virtual machine, a physical host 1, and a physical host 2 are all of a periodic type. A virtual resource utilization curve of the virtual machine, a physical resource utilization curve of the physical host 1, and a physical resource utilization curve of the physical host 2 are shown in FIG. 6. A CPU utilization fitting curve of the virtual machine in one period is y=sin x, and a CPU utilization fitting curve of the physical host 1 in one period is y=sin x, and a CPU utilization fitting curve of the physical host 2 in one period is y=sin x. It can be learned from FIG. 6 that although current CPU utilization of the physical host 1 is 28% and current CPU utilization of the physical host 2 is 20%, the CPU utilization curve of the physical host 2 and the CPU utilization curve of the virtual machine do not satisfy a peak-shaving and valley-filling feature. If the resource migration method provided in this disclosure is not used, only the current CPU utilization is considered, and a resource of the virtual machine is migrated to the physical host 2, at a specific time point when the CPU utilization curve of the physical host 2 reaches a highest state, CPU usage of the physical host 2 may be very high or even a resources crash may occur, which brings inconvenience to a user. Although current CPU utilization of the physical host 1 is higher than the current CPU utilization of the physical host 2, the CPU utilization curve of the physical host 1 satisfies a peak-shaving and valley-filling feature with the CPU utilization curve of the virtual machine. If the resource migration method provided in this disclosure is used, after a resource of the virtual machine is migrated to the physical host 1, the CPU utilization curve of the physical host 1 keeps a stable state. In this way, that resource utilization of the target physical host fluctuates after resource migration is avoided, and further a service delay in a resource migration process is avoided.

In conclusion, the resource migration method provided in this disclosure may identify the resource types of the virtual machine in the to-be-migrated resource pool 110 and the physical host in the target resource pool 120. For the stable-type virtual machine, the stable-type physical host with the smallest predicted value of physical resource utilization is selected as the target physical host for resource migration. For the periodic-type virtual machine, the periodic-type resource whose physical resource utilization curve satisfies the peak-shaving and valley-filling feature with the virtual resource utilization curve of the virtual machine is selected as the target physical host for resource migration. In a process of determining the target physical host, the system not only considers a current resource utilization status of the virtual machine, but also considers a possible physical resource utilization status of the target physical host that is obtained after migration. Based on this, a target physical host with a high matching degree may be selected for resource migration. This greatly avoids waste of resources, improves efficiency of resource migration, stability of a cloud service system, and resource utilization in the entire resource pool, reduces operation costs of a cloud service provider, and avoids a service delay, so that user experience is improved.

The method in embodiments of this disclosure is described in detail above. For ease of better implementing the solutions in embodiments of this disclosure, correspondingly, related devices used to cooperate in implementing the solutions are further provided below.

FIG. 7 is a schematic diagram of a structure of a resource migration system 700 according to this disclosure. As shown in FIG. 7, the system 700 may be applied to the resource provisioning system 100 in the foregoing content. The resource provisioning system 100 includes at least one physical host, each of the at least one physical host includes a plurality of types of hardware resources, the hardware resources of each of the at least one physical host are virtualized into a plurality of types of virtual resources for use by a virtual machine running on the physical host, and the resource migration system 700 includes an obtaining unit 710, an identification unit 720, and a migration unit 730.

The obtaining unit 710 is configured to obtain virtual resource utilization of a virtual machine, where the virtual resource utilization of the virtual machine includes any one or more of the following: virtual CPU utilization, virtual memory utilization, and virtual disk utilization.

The identification unit 720 is configured to: input the virtual resource utilization of the virtual machine into an identification model, and determine a resource type of the virtual machine.

The obtaining unit 710 is further configured to obtain physical resource utilization of the at least one physical host, where the physical resource utilization of the at least one physical host includes any one or more of the following: CPU utilization, memory utilization, and disk utilization.

The identification unit 720 is further configured to: input the physical resource utilization of the at least one physical host into the identification model, and determine a resource type of each of the at least one physical host.

The migration unit 730 is configured to migrate the virtual machine to one of the at least one physical host based on the resource type of the virtual machine and the resource type of each of the at least one physical host.

In an embodiment, the resource type of the virtual machine includes a stable type. When the resource type of the virtual machine is the stable type, the obtaining unit 710 is further configured to obtain at least one stable-type physical host whose resource type is the stable type, the migration unit 730 is further configured to predict, based on the virtual resource utilization of the virtual machine and physical resource utilization of the at least one stable-type physical host, a predicted value of physical resource utilization obtained after the virtual machine is migrated to each of the at least one stable-type physical host, to obtain at least one predicted value of physical resource utilization, the migration unit 730 is further configured to determine that a stable-type physical host corresponding to a smallest predicted value of physical resource utilization in the at least one predicted value of the physical resource utilization as a target physical host, and the migration unit 730 is further configured to migrate the virtual machine to the target physical host.

In an embodiment, the resource type of the virtual machine includes a periodic type. When the resource type of the virtual machine is the periodic type, the obtaining unit 710 is further configured to obtain at least one periodic-type physical host whose resource type is the periodic type, the migration unit 730 is further configured to determine, based on the virtual resource utilization of the virtual machine and physical resource utilization of the at least one periodic-type physical host, a periodic-type physical host whose physical resource utilization curve satisfies a peak-shaving and valley-filling feature with a virtual resource utilization curve of the virtual machine as a target physical host, where when the virtual machine is in a highest utilization state, the periodic-type physical host whose physical resource utilization curve satisfies the peak-shaving and valley-filling feature with the virtual resource utilization curve is in a lowest utilization state, or when the virtual machine is in a lowest utilization state, the periodic-type physical host whose physical resource utilization curve satisfies the peak-shaving and valley-filling feature with the virtual resource utilization curve is in a high utilization state, and the migration unit 730 is further configured to migrate the virtual machine to the target physical host.

In an embodiment, the identification unit 720 is configured to: determine a CV between each piece of data and at least one piece of other data in virtual resource utilization of each of at least one virtual machine, to obtain at least one CV coefficient vector, where each of the at least one CV coefficient vector corresponds to one virtual machine, and each of the at least one CV coefficient vector includes at least one CV coefficient; cluster the at least one CV coefficient vector to obtain at least one first coefficient set, where each of the at least one first coefficient set includes at least one CV coefficient vector, and each of the at least one first coefficient set corresponds to at least one virtual machine; and determine that at least one virtual machine that corresponds to a first coefficient set in which each CV coefficient is less than a threshold is of a stable type.

In an embodiment, the identification unit 720 is further configured to: after the at least one CV coefficient is clustered to obtain the at least one first coefficient set, re-cluster a CV coefficient vector in at least one first coefficient set in which a CV coefficient is greater than the threshold, to obtain at least one second coefficient set, where each of the at least one second coefficient set includes at least one CV coefficient vector, and each of the at least one second coefficient set corresponds to at least one virtual machine; and determine that at least one virtual machine corresponding to a second coefficient set in which each CV coefficient is less than the threshold is of a stable type.

In an embodiment, the identification unit 720 is configured to: perform Fourier transform on the virtual resource utilization of the virtual machine to obtain a Fourier curve; determine a difference between a peak and a trough of the Fourier curve; and when the difference is less than a threshold, determine that a virtual machine corresponding to the Fourier curve is of a periodic type.

It should be understood that internal unit modules of the resource migration system 700 shown in FIG. 7 may also be divided into a plurality of types of modules, and the modules may be software modules, or may be hardware modules, or some may be software modules and the other may be hardware modules. This is not limited in this disclosure. FIG. 7 is an example of a division manner. This is not limited in this disclosure.

In conclusion, the resource migration system 700 provided in this disclosure may identify the resource types of the virtual machine in a to-be-migrated resource pool 110 and the physical host in a target resource pool 120. For the stable-type virtual machine, the stable-type physical host with the smallest predicted value of physical resource utilization is selected as the target physical host for resource migration. For the periodic-type virtual machine, the periodic-type resource whose physical resource utilization curve satisfies the peak-shaving and valley-filling feature with the virtual resource utilization curve of the virtual machine is selected as the target physical host for resource migration. In a process of determining the target physical host, the system not only considers a current resource utilization status of the virtual machine, but also considers a possible physical resource utilization status of the target physical host that is obtained after migration. Based on this, a target physical host with a high matching degree may be selected for resource migration. This greatly avoids waste of resources, improves efficiency of resource migration, stability of a cloud service system, and resource utilization in the entire resource pool, reduces operation costs of a cloud service provider, and avoids a service delay, so that user experience is improved.

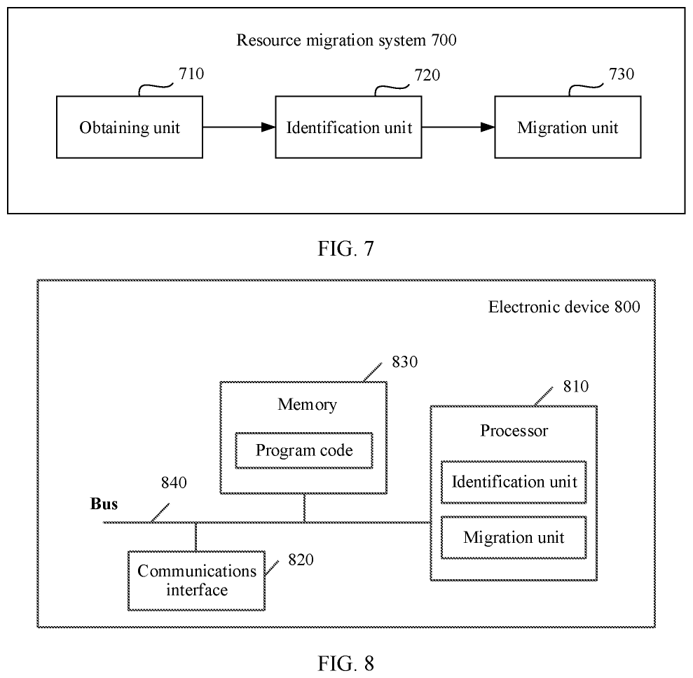

FIG. 8 is a schematic diagram of a structure of an electronic device 800 according to an embodiment of this disclosure. The electronic device 800 may be the resource migration system 200 or the resource migration system 700 in the foregoing content. As shown in FIG. 8, the electronic device 800 includes a processor 810, a communications interface 820, and a memory 830. The processor 810, the communications interface 820, and the memory 830 may be connected to each other through an internal bus 840, or may implement communication in another manner, for example, wireless transmission. In this embodiment of this disclosure, an example in which the bus 840 is used for connection is used. The bus 840 may be a Peripheral Component Interconnect (PCI) bus, an Extended Industry Standard Architecture (EISA) bus, or the like. The bus 840 may be classified into an address bus, a data bus, a control bus, or the like. For ease of representation, the bus is represented by using only one bold line in FIG. 8. However, it does not indicate that there is only one bus or only one type of bus.

The processor 810 may include at least one general-purpose processor, for example, a CPU or a combination of a CPU and a hardware chip. The hardware chip may be an application-specific integrated circuit (ASIC), a programmable logic device (PLD), or a combination thereof. The PLD may be a complex programmable logic device (CPLD), a field-programmable gate array (FPGA), generic array logic (GAL), or any combination thereof. The processor 810 executes various types of digital storage instructions, for example, software or firmware programs stored in the memory 830, so that the electronic device 800 can provide a plurality of types of services in a wide range. In specific implementation, the processor 810 may include an identification unit and a migration unit. The identification unit may invoke program code in the memory 830 to implement a processing function, including the described function of the identification module 210 in FIG. 2 and the described function of the identification unit 720 in FIG. 7. For example, the identification unit determines a resource type of a virtual machine based on collected virtual resource utilization of the virtual machine. The identification unit may be configured to perform S302 of the foregoing method and an optional step thereof, and may be further configured to perform other steps described in the embodiments shown in FIG. 2 to FIG. 6. Details are not described herein again. The migration unit may invoke program code in the memory 830 to implement a processing function, including the described function of the migration module 220 in FIG. 2 and the described function of the migration unit 730 in FIG. 7. For example, the migration unit migrates a virtual machine to one of at least one physical host based on a resource type of the virtual machine and a resource type of each of the at least one physical host. The migration unit may be configured to perform step S303, step S304, step S305 of the foregoing method and optional steps thereof, and may be further configured to perform other steps described in the embodiments shown in FIG. 2 to FIG. 6. Details are not described herein again.

The memory 830 may include a volatile memory, for example, a random-access memory (RAM). The memory 830 may also include a non-volatile memory, for example, a read-only memory (ROM), a flash memory, a hard disk drive (HDD), or a solid-state drive (SSD). The memory 830 may further include a combination of the foregoing types of memories. In a specific implementation, the memory 830 stores program code. The program code may be code for identifying a stable-type virtual machine and a stable-type physical host, code for identifying a periodic-type virtual machine and a periodic-type physical host, code for a stable migration solution, code for a periodic migration solution, and the like, and may further include other program code for performing other steps described in the embodiments in FIG. 2 to FIG. 6, which are not described herein again.

The communications interface 820 may be a wired interface (for example, an Ethernet interface), an internal interface (for example, a high-speed serial computer extended bus interface (e.g., PCI Express (PCIe)), a wired interface (for example, an Ethernet interface), or a wireless interface (for example, a cellular network interface or a wireless local area network interface). The communications interface 820 is configured to communicate with another device or module.

It should be noted that FIG. 8 is merely a possible implementation of embodiments of this disclosure. In actual application, the electronic device may further include more or fewer components. This is not limited herein. For content that is not shown or not described in this embodiment of this disclosure, refer to related descriptions in the embodiments shown in FIG. 2 to FIG. 6. Details are not described herein again.

It should be understood that the electronic device shown in FIG. 8 may alternatively be a computer cluster including at least one server. This is not limited in this disclosure.

An embodiment of this disclosure further provides a computer-readable storage medium. The computer-readable storage medium stores instructions. When the instructions are run on a processor, the method procedures shown in FIG. 2 to FIG. 6 are implemented.

An embodiment of this disclosure further provides a computer program product. When the computer program product is run on a processor, the method procedures shown in FIG. 2 to FIG. 6 are implemented.

All or some of the foregoing embodiments may be implemented by software, hardware, firmware, or any combination thereof. When software is used to implement embodiments, the foregoing embodiments may be implemented partially in a form of a computer program product. The computer program product includes at least one computer instruction. When the computer program instructions are loaded or executed on a computer, all or some of the procedures or functions according to embodiments of the present disclosure are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another web site, computer, server, or data center in a wired (for example, a coaxial cable, an optical fiber, or a digital subscriber line (digital subscriber line (DSL)) or wireless (for example, infrared, radio, or microwave) manner. The computer-readable storage medium may be any usable medium accessible by a computer, or a data storage device, such as a server or a data center, integrating at least one usable medium. The usable medium may be a magnetic medium (for example, a floppy disk, a hard disk drive, or a magnetic tape), an optical medium (for example, a high-density digital video disc (DVD)), or a semiconductor medium. The semiconductor medium may be an SSD.

The foregoing descriptions are merely specific embodiments of the present disclosure, but are not intended to limit the protection scope of the present disclosure. Any modification or replacement readily figured out by persons skilled in the art within the technical scope disclosed in the present disclosure shall fall within the protection scope of the present disclosure. Therefore, the protection scope of the present disclosure shall be subject to the protection scope of the claims.

1. A resource migration method implemented by a resource provisioning system, wherein the resource migration method comprises:
obtaining virtual resource utilization of a virtual machine;
inputting the virtual resource utilization into an identification model;
determining, by the identification model and based on the virtual resource utilization, a first resource type of the virtual machine;
obtaining a first physical resource utilization of a physical host;
inputting the first physical resource utilization into the identification model;
determining, by the identification model and based on the first physical resource utilization, a second a resource type of the physical host; and
migrating, based on the first resource type and the second resource type, the virtual machine to the physical host.

2. The resource migration method of claim 1, wherein the first resource type comprises a stable type, and wherein when the second resource type comprises the stable type, migrating the virtual machine to the physical host comprises:
obtaining a plurality of stable-type physical hosts having a third resource type, wherein the third resource type comprises the stable type;
predicting, based on the virtual resource utilization and second physical resource utilizations of the stable-type physical hosts, predicted physical resource utilization values obtained after the virtual machine is migrated to each of the stable-type physical hosts;
determining one of the stable-type physical hosts corresponding to a smallest predicted value in the predicted physical resource utilization values as a target physical host; and
migrating the virtual machine to the target physical host.

3. The resource migration method of claim 1, wherein the first resource type comprises a periodic type, and wherein when the second resource type comprises the periodic type, migrating the virtual machine to the physical host comprises:
obtaining a plurality of periodic-type physical hosts having a third resource type, wherein the third resource type comprises the periodic type;
determining, based on the virtual resource utilization and second physical resource utilizations of the periodic-type physical hosts, one of the periodic-type physical hosts having a physical resource utilization curve that satisfies a peak-shaving and valley-filling feature with a virtual resource utilization curve of the virtual machine as a target physical host, wherein when the virtual machine is in a first highest utilization state, the one of the periodic-type physical hosts is in a first lowest utilization state, or when the virtual machine is in a second lowest utilization state, the one of the periodic-type physical hosts is in a second high utilization state; and
migrating the virtual machine to the target physical host.

4. A resource migration system, comprising:
a memory configured to store instructions; and
a processor coupled to the memory and configured to execute the instructions to cause the resource migration system to:
obtain virtual resource utilization of a virtual machine;
input the virtual resource utilization into an identification model;
determine, by the identification model and based on the virtual resource utilization, a first resource type of the virtual machine;
obtain a first physical resource utilization of a physical host;
input the first physical resource utilization into the identification model;
determine, by the identification model and based on the first physical resource utilization, a second resource type of the physical host; and
migrate, based on the first resource type and the second resource type, the virtual machine to the physical host.

5. The resource migration system of claim 4, wherein the first resource type comprises a stable type, and wherein when the second resource type comprises the stable type, the processor is further configured to execute the instructions to cause the resource migration system to:
obtain a plurality of stable-type physical hosts having a third resource type, wherein the third resource type comprises the stable type;
predict, based on the virtual resource utilization and second physical resource utilizations of the stable-type physical hosts, predicted physical resource utilization values obtained after the virtual machine is migrated to each of the stable-type physical hosts;
determine one of the stable-type physical hosts corresponding to a smallest predicted value in the predicted physical resource utilization values as a target physical host; and
migrate the virtual machine to the target physical host.

6. The resource migration system of claim 4, wherein the first resource type comprises a periodic type, and wherein when the second resource type comprises the periodic type, the processor is further configured to execute the instructions to cause the resource migration system to:
obtain a plurality of periodic-type physical hosts having a third resource type, wherein the third resource type comprises the periodic type;
determine, based on the virtual resource utilization and second physical resource utilizations of the periodic-type physical hosts, one of the periodic-type physical hosts having a physical resource utilization curve that satisfies a peak-shaving and valley-filling feature with a virtual resource utilization curve of the virtual machine as a target physical host, wherein when the virtual machine is in a first highest utilization state, the one of the periodic-type physical hosts is in a first lowest utilization state, or when the virtual machine is in a second lowest utilization state, the one of the periodic-type physical hosts is in a second high utilization state; and
migrate the virtual machine to the target physical host.

7. (canceled)

8. The resource migration system of claim 4, wherein the first resource type comprises a periodic type, and wherein when the second resource type comprises the periodic type, the processor is further configured to execute the instructions to cause the resource migration system to:
obtain a plurality of periodic-type physical hosts having a third resource type, wherein the third resource type comprises the periodic type;
determine, based on the virtual resource utilization and second physical resource utilizations of the periodic-type physical hosts, one of the periodic-type physical hosts having a physical resource utilization curve that satisfies a peak-shaving and valley-filling feature with a virtual resource utilization curve of the virtual machine as a target physical host, wherein when the virtual machine is in a highest utilization state, the one of the periodic-type physical hosts is in a lowest utilization state; and
migrate the virtual machine to the target physical host.

9. The resource migration system of claim 4, wherein the first resource type comprises a periodic type, and wherein when the second resource type comprises the periodic type, the processor is further configured to execute the instructions to cause the resource migration system to:
obtain a plurality of periodic-type physical hosts having a third resource type, wherein the third resource type comprises the periodic type;
determine, based on the virtual resource utilization and second physical resource utilizations of the periodic-type physical hosts, one of the periodic-type physical hosts having a physical resource utilization curve that satisfies a peak-shaving and valley-filling feature with a virtual resource utilization curve of the virtual machine as a target physical host, wherein when the virtual machine is in a lowest utilization state, the one of the periodic-type physical hosts is in a high utilization state; and
migrate the virtual machine to the target physical host.

10. The resource migration system of claim 4, wherein the first physical resource utilization comprises a central processing unit (CPU) utilization.

11. The resource migration system of claim 4, wherein the first physical resource utilization comprises memory utilization.

12. The resource migration system of claim 4, wherein the first physical resource utilization comprises disk utilization.

13. The resource migration system of claim 4, wherein the virtual resource utilization comprises virtual central processing unit (CPU) utilization.

14. The resource migration system of claim 13, wherein the virtual CPU utilization comprises a current CPU resource utilization, a historical CPU resource utilization curve, or average CPU utilization.

15. The resource migration system of claim 4, wherein the virtual resource utilization comprises virtual memory utilization.

16. The resource migration system of claim 15, wherein the virtual memory utilization comprises current memory utilization, a historical memory utilization curve, or average memory utilization.

17. The resource migration system of claim 4, wherein the virtual resource utilization comprises virtual disk utilization.

18. The resource migration system of claim 17, wherein the virtual disk utilization comprises current disk utilization, a historical disk utilization curve, or average disk utilization.

19. The resource migration method of claim 1, wherein the first resource type comprises a periodic type, and wherein when the second resource type comprises the periodic type, migrating the virtual machine to the physical host comprises:
obtaining a plurality of periodic-type physical hosts having a third resource type, wherein the third resource type comprises the periodic type;
determining, based on the virtual resource utilization and second physical resource utilizations of the periodic-type physical hosts, one of the periodic-type physical hosts having a physical resource utilization curve that satisfies a peak-shaving and valley-filling feature with a virtual resource utilization curve of the virtual machine as a target physical host, wherein when the virtual machine is in a highest utilization state, the one of the periodic-type physical hosts is in a lowest utilization state; and
migrating the virtual machine to the target physical host.

20. The resource migration method of claim 1, wherein the first resource type comprises a periodic type, and wherein when the second resource type comprises the periodic type, migrating the virtual machine to the physical host comprises:
obtaining a plurality of periodic-type physical hosts having a third resource type, wherein the third resource type comprises the periodic type;
determining, based on the virtual resource utilization and second physical resource utilizations of the periodic-type physical hosts, one of the periodic-type physical hosts having a physical resource utilization curve that satisfies a peak-shaving and valley-filling feature with a virtual resource utilization curve of the virtual machine as a target physical host, wherein when the virtual machine is in a lowest utilization state, the one of the periodic-type physical hosts is in a high utilization state; and
migrating the virtual machine to the target physical host.

21. A computer program product comprising instructions stored on a non-transitory computer-readable medium that, when executed by a processor, cause an electronic device to:
obtain virtual resource utilization of a virtual machine;
input the virtual resource utilization into an identification model;
determine, by the identification model and based on the virtual resource utilization, a first resource type of the virtual machine;
obtain a first physical resource utilization of a physical host;
input the first physical resource utilization into the identification model;
determine, by the identification model and based on the first physical resource utilization, a second resource type of the physical host; and
migrate, based on the first resource type and the second resource type, the virtual machine to the physical host.
